(19) United States
(12) Patent Application Publication
(10) Pub. No.: US 2020/0223011 A1
(43) Pub. Date: Jul. 16, 2020

(54) Installation for the Powder-Bed-Based Additive Manufacturing of a Workpiece, Comprising Multiple Metering Devices for Different Types of Powder

(71) Applicant: Siemens Aktiengesellschaft, München (DE)

(72) Inventors: Oliver Hofacker, Berlin (DE); Ursus Krüger, Berlin (DE)

(73) Assignee: Siemens Aktiengesellschaft, München (DE)

(21) Appl. No.: 16/633,752

(22) PCT Filed: Jun. 29, 2018
(86) PCT No.: PCT/EP2018/067633

§ 371 Date: Jan. 24, 2020

(30) Foreign Application Priority Data
Jul. 28, 2017 (DE) 10 2017 213 087.3

(51) Int. Cl. B23K 26/342; B33Y 30/00; B33Y 40/10; B23K 26/06; B23K 26/12; B23K 26/14

(52) U.S. Cl. CPC B23K 26/342; B33Y 30/00; B33Y 40/10; B33Y 10/00; B23K 26/127; B23K 26/1464; B23K 26/0643

(57) ABSTRACT

Various embodiments include an installation for the powder-bed-based additive manufacturing of a workpiece, the installation comprising: a process chamber; a receiving device for a powder bed in the process chamber; multiple metering devices for different types of powder, wherein the metering devices each have a cavity and a metering slit; and a plurality of storage containers, with at least one storage container for each of the multiple metering devices, wherein each storage container feeds in the respective cavity of the metering device. The metering slits are arranged radially in relation to a perpendicular center axis running through the receiving device. The receiving device and the metering devices rotate in relation to one another about the center axis.

### CROSS-REFERENCE TO RELATED APPLICATIONS

This application is a U.S. National Stage Application of International Application No. PCT/EP2018/067633 filed Jun. 29, 2018, which designates the United States of America, and claims priority to DE Application No. 10 2017 213 087.3 filed Jul. 28, 2017, the contents of which are hereby incorporated by reference in their entirety.

### TECHNICAL FIELD

The present disclosure relates to additive manufacturing. Various embodiments of the teachings herein may include installations for the powder-bed-based additive manufacturing of a workpiece and/or methods for operating such an installation.

### BACKGROUND

Within the context of this disclosoure, powder-bed-based additive manufacturing refers to methods in which the material from which a component is to be manufactured are added to the component during its creation. In this case, the component is already created in its final form, or at least approximately in this form. The building material is powdered, the material for manufacturing the component being fused by the additive production method layer by layer by an energy beam.

In order to be able to manufacture the component, data describing the component (CAD model) are prepared for the chosen additive production method. To create instructions for the production installation, the data are converted into data of a workpiece to be manufactured that are adapted to the production method, in order that the suitable process steps for successively manufacturing this workpiece can proceed in the production installation. For this, the data are prepared in such a way that the geometrical data for the layers (slices) of the workpiece respectively to be manufactured are available, which is also referred to as slicing. The workpiece may have a form that deviates from the component. For example, allowance may be made for a manufacturing-dependent component distortion, which is compensated by a deviating workpiece geometry. The workpiece also usually has supporting structures, which have to be removed again during the finishing of the component.

Selective laser sintering (also known as SLS), selective laser melting (also known as SLM) and electron-beam melting (also known as EBM) are examples of additive production. These methods are suitable in particular for the processing of metallic materials in the form of powders with which construction components can be manufactured. In the case of SLM, SLS, and EBM, the components are manufactured layer by layer in a powder bed. In each case, a layer of the powder is created in the powder bed and is subsequently locally melted or sintered by the energy source (laser or electron beam) in those regions in which the component is to be created. Thus, the component is successively created layer by layer and, after completion, can be removed from the powder bed.

US 2015/0352784 A1 describes an additive manufacturing system. In order to be able to manufacture a workpiece layer by layer from multiple materials by a powder bed-based additive production method, it is proposed that multiple storage containers for different types of powder may be arranged around a receiving device for a powder bed to be created. The storage containers provide a surface of the respective type of powder that is located on a level with the surface of the powder bed to be created. By means of slides, a defined amount of powder can then be displaced in each case from the powder store to the powder bed. Because the storage containers have to be arranged with their surface on the same level as the powder bed in order for the metering by means of the slides to work, such an installation for additive production has a significantly greater installation space than an installation in which only one type of powder has to be processed.

DE 10 2014 221 885 A1 describes an installation for powder-bed-based additive manufacturing that has multiple metering devices, which are aligned radially in relation to a perpendicular center axis running through the receiving device. These metering devices can be rotated about the center axis and thereby supply the powder onto a powder bed, which has a circular surface. As a result, it is possible to meter in powder a number of times in one revolution, the powder being respectively fused by lasers that are arranged in each case between the metering devices.

### SUMMARY

The teachings of the present disclosure describe installations for the powder-bed-based additive production of workpieces which combine the possibility of processing multiple types of powder in a powder bed with a compact form of construction. For example, some embodiments include an installation for the powder-bed-based additive manufacturing of a workpiece (11), comprising a process chamber (21), in which a receiving device (12) for a powder bed (13) is provided, multiple metering devices (23a, 23b, 23c, 23d) for different types of powder are provided, wherein the metering devices (23a, 23b, 23c, 23d) each have a cavity (27a), each with a metering slit (28a), it being possible for a certain type of powder to be applied to each of the cavities (27a), the metering slits (28a) are arranged radially in relation to a perpendicular center axis (31) running through the receiving device, the receiving device (12) and the metering devices (23a, 23b, 23c, 23d) are rotatable in relation to one another about the center axis (31), characterized in that the metering devices (23a, 23b, 23c, 23d) are each equipped with a storage container (24a, 24b, 24c, 24d), which is in each case in connection with the cavity (27a) of the metering device (23a, 23b, 23c, 23d).

In some embodiments, the receiving device (12) has an inner border (15) for the powder bed, which separates a region lying around the center axis (31) from the powder bed to be formed.

In some embodiments, a slide (34) for smoothing a surface of the powder bed to be created is provided, the slide (34) is aligned radially in relation to the center axis (31), the receiving device (12) and the slide (34) are rotatable in relation to one another about the center axis (31).

In some embodiments, the receiving device (12) has an opening (36) for excess powder, which is adjacent to an outer border (14) for the powder bed (13) and leads into a collecting container (35).

In some embodiments, the opening (36) completely surrounds the outer border (14).

In some embodiments, the receiving device (12) has an opening (36) for excess powder, which is adjacent to an inner border (15) for the powder bed (13) and leads into a collecting container (35).

In some embodiments, the slide (34) has in a plan view from above a curved shape.

In some embodiments, the storage containers (24a, 24b, 24c, 24d) are arranged in the process chamber (21) and a filling device (38a, 38b, 38c, 38d), which can be charged with the relevant type of powder outside the process chamber (21), is provided for each storage container (24a, 24b, 24c, 24d).

As another example, some embodiments include a method for operating an installation for the powder-bed-based additive manufacturing of a workpiece (11), comprising a process chamber (21), in which a receiving device (12) for a powder bed (13) is provided, multiple metering devices (23a, 23b, 23c, 23d) for different types of powder are provided, with which the powder bed (13) in the receiving device is produced layer by layer, wherein the metering slits (28a) are aligned radially in relation to a perpendicular center axis (31) running through the receiving device, the receiving device (12) and the metering devices (23a, 23b, 23c, 23d) are rotated in relation to one another about the center axis (31), while at least one of the types of powder is being distributed on the powder bed through the associated metering slit (28a), characterized in that the metering devices (23a, 23b, 23c, 23d) are each equipped with a storage container (24a, 24b, 24c, 24d), which is in each case in connection with the cavity (27a) of the metering device (23a, 23b, 23c, 23d), the metering devices (23a, 23b, 23c, 23d) each have a cavity (27a), each with a metering slit (28a), a certain type of powder from the respective powder container being applied to each of the cavities (27a).

In some embodiments, at least two types of powder are distributed on the powder bed through the associated metering slits (28a) to create one and the same layer of the powder bed (13), the types of powder being mixed together.

In some embodiments, the mixing ratio of the types of powder is set by the rotational speed between the metering devices (23a, 23b, 23c, 23d) and the receiving device (12).

In some embodiments, the rotational speed is varied during the metering of the respective type of powder.

In some embodiments, a change of the use of the metering devices (23a, 23b, 23c, 23d) takes place between the application of two adjacent layers.

### BRIEF DESCRIPTION OF THE DRAWINGS

The exemplary embodiments explained below describe components of example embodiments which represent individual features of the teachings herein which are to be considered independently of one another and which each also develop the disclosure independently of one another and can therefore also be considered to be a component, either individually or in a combination other than that shown. Furthermore, further features which have already been described can also be added to the described embodiment.

In the drawings:

FIG. 1 shows schematically in section an embodiment of an installation incorporating teachings of the present disclosure, on which an embodiment of a method incorporating teachings of the present disclosure is carried out;

FIG. 2 shows a plan view of the receiving device and the metering device of the installation according to FIG. 1 from above, the sectional plane I-I according to FIG. 1 being depicted,

FIG. 3 shows a division of the powder bed for carrying out the method according to FIG. 1,

FIG. 4 shows an embodiment of an installation incorporating teachings of the present disclosure with a cut-open housing and a plan view of the receiving device and also the metering device.

### DETAILED DESCRIPTION

In some embodiments, the metering devices each have a cavity, each with a metering slit, it being possible for a certain type of powder to be applied to each of the cavities (and consequently for different types of powder to be applied). Furthermore, the metering slits of the metering devices are arranged radially in relation to a perpendicular center axis running through the receiving device, which may lie in the central region of the powder bed to be created. In other words, the center axis runs through the receiving device in which the powder bed is to be created. To be specific, the receiving device and the metering devices are rotatable in relation to one another about the center axis, and so it is ensured by this relative rotational movement that the entire surface of the powder bed to be created can be reached by the metering slit. The relative movement is in this case comparable to the hands of a clock running around a clock face (while instead of the hands alternatively the face can also be rotated). The relative movement can consequently also be created by rotation of the receiving device about the center axis.

In some embodiments, the powder bed is lowerable or alternatively the metering devices are raisable. In this way it may be ensured that the powder bed can be created layer by layer without collisions occurring between the metering devices and the surface of the powder bed.

The receiving device may be equipped with a cylindrical receiving space for the powder bed. The center axis is then identical to the axis of symmetry of the cylindrical receiving space. As a result, a particularly compact form of construction of the installation is possible. Furthermore, the metering devices can then be adapted to the geometry of the receiving device, since a border for the powder bed is then always at the same distance from the center axis. In some embodiments, the receiving device may also have a differently designed receiving space, which for example provides a square surface of the powder bed to be created. Other surfaces, for example that of a regular hexagon or some other polygon, are also conceivable.

The fact that the metering devices are arranged radially in relation to the center axis means that they can be arranged in a small space above the powder bed. Metering of the powder in this case takes place directly through the metering slits of the metering devices, which makes the space-saving arrangement above the receiving device for the powder bed possible in the first place. By applying various types of powder to the metering devices, multi-material processing becomes possible, in that the powder bed is built up with different types of powder.

In some embodiments, the receiving device has an inner border for the powder bed, which separates a region lying around the center axis from the powder bed to be formed. This means that no powder bed is created in the region of the center axis, since the inner border prevents the creation of the powder bed in this region. Because of the rotating relative movement and the small distance from the center axis, in this region metering of powder is only possible with difficulty, and so no powder bed is created within the inner border. This saves powder material, and consequently reduces the production costs for workpieces to be additively manufactured. The inner border may for example be formed by a cylindrical dome, the flat upper side of which lies exactly at the height of the surface of the powder bed. This then takes up exactly the volume that is to be left free in the powder bed.

In some embodiments, a slide for smoothing a surface of the powder bed to be created is provided. In a way similar to the metering devices, this slide is aligned radially in relation to the center axis and is rotatable about the center axis in relation to the receiving device. The slide is arranged at the height of the surface of the powder bed to be created in such a way that its displacement leads to the smoothing of the powder bed. In particular, excess powder material can be removed from the surface of the powder bed. In some embodiments, multiple slides are used, in particular one slide per powder conveyor. However, it is also possible to arrange only one slide, which, by a sufficiently great relative rotation between the slide and the receiving device, can reach the powder supplied through each metering device. The slide consequently contributes advantageously to improved quality of the surface of the powder bed.

In some embodiments, the receiving device has an opening for excess powder, which is adjacent to an outer border for the powder bed and leads into a collecting container. If excess powder is deposited by the slide on the surface of the powder bed to be created, it can pass over the outer border safely into the collecting container and be stored there. This makes reliable disposal or re-use of the powder possible. The opening may surround the outer border completely. In this way, all of the powder that is carried radially outward by the slide can pass via the opening into the collecting container. The opening may be formed as an annular slit, which surrounds the outer border.

In some embodiments, the receiving device has an opening for excess powder, which is adjacent to the inner border for the powder bed and opens out into a collecting container. This makes it possible to receive excess powder, which can pass via the central opening into the collecting container. The advantages associated with this have already been explained. Furthermore, this configuration may be particularly space-saving, because the region of the inner border that is not to be taken up by the powder bed would otherwise remain unused.

In some embodiments, the slide has in a plan view from above a curved shape. In this case, the slide as a whole is arranged with its curved shape radially in relation to the center axis, the alignment of the edge of the slide changing in the radial shape of the slide. Depending on the curvature, as a result excess powder at the edge of the slide is carried outward or inward, so that disposal of this excess powder in the collecting containers is facilitated.

If the slide brushes over the powder bed with its convex side in front, the powder is carried radially inward during the operation of the slide and can pass over the inner border of the receiving device via the opening into the collecting container. If the slide brushes over the powder bed with its concave side in front, excess powder is pushed outward over the outer border of the receiving device and can fall into the preferably annular opening, in order in this way to pass into the collecting container. In this case, it is prevented that the amount of excess powder in front of the slide becomes so great that it falls over the upper edge of the slide onto the already smoothed powder bed.

In some embodiments, the metering devices are each equipped with a storage container, which is in each case in connection with the cavity of the metering device. The storage containers receive a certain amount of the type of powder respectively to be processed, which can be supplied via the connection of the cavity of the metering device. The cavity then serves for distributing the powder over the length of the slit, so that it can be distributed uniformly on the powder bed. For this purpose, separating walls that divide the flow of the powder and thus supply to different portions of the metering slit may be provided in the cavity. This may have the effect of making the application of powder more uniform over the length of the slit. In this case, allowance may also be made for the fact that a smaller amount of powder has to be supplied per unit of time in radially inner portions of the metering slit than in radially outer portions of the metering slit, since the metering slit has to cover a greater distance per revolution on the outside than on the inside.

In some embodiments, the storage containers are arranged in the process chamber and a filling device, which can be charged with the relevant type of powder outside the process chamber, is provided for each storage container. This variant may be advantageous if the metering devices are rotated to create the powder bed. The storage containers can receive sufficient powder during the movement of the metering devices that it can be distributed on the powder bed via the metering slits. If the storage containers are empty, the metering device concerned can be brought up to the filling device, and so the corresponding type of powder can be replenished from outside the process chamber. In this case, the process chamber does not need to be opened, and so contamination of the process chamber on account of environmental influences can be prevented. Furthermore, it is prevented that powder from the process chamber can reach the outside. Lastly, the downtimes of the installation associated with the refilling of the storage containers can be minimized.

In some embodiments, the metering devices each have a cavity, each with a metering slit, a certain type of powder being applied to each of the cavities. As already mentioned, the metering slits are arranged radially in relation to a perpendicular center axis running through the receiving device. The receiving device and the metering devices are rotated in relation to one another about the center axis, while at least one of the types of powder is being distributed on the powder bed through the associated metering slit. In this case, the installation used in the method may have the properties that have already been explained in more detail above. The methods described herein make possible different operating modes, by which the possibilities for the design of the additively manufactured workpieces may be increased, as to be explained in more detail below.

In some embodiments, at least two types of powder are distributed on the powder bed through the associated metering slits to create one and the same layer of the powder bed, the types of powder being mixed together. In this way it is possible to produce layers of the workpiece that do not only consist of one type of powder. For example, by mixing metallic powders, the production of metal alloys can be achieved, these being created by diffusion processes during the melting or sintering of the powder. In some embodiments, the alloy formation can be achieved in that powder of the alloying constituents (types of powder) are mixed with one another in the correct mixing ratio. It is therefore unnecessary to keep alloying powders, which reduces the costs involved in stockkeeping raw materials.

In some embodiments, the mixing ratio of the types of powder is set by the rotational speed between the metering devices and the receiving device. Thus, for example, a type of powder that is intended to be of a high concentration can be distributed by a lower rotational speed, and so the rotation of the metering device on the powder bed takes longer and in this way more powder trickles through the metering slit. The type of powder that is to be metered in a lower concentration is accordingly applied to the powder bed at a higher rotational speed. As a result, greater freedom of design for the mixing of powders is advantageously exploited. In some embodiments, the rotational speed is varied during the metering of the respective type of powder. This makes it possible to vary locally the mixing ratio of the types of powder in the layer of the powder bed that is to be produced in each instance. In particular, it is also possible to create a concentration gradient of a type of powder in a layer, the concentration gradient being aligned in the circumferential direction in the powder bed.

In some embodiments, a change of the use of the metering devices takes place between the application of two adjacent layers. Also in this way, an alloy formation is possible in the case of metallic types of powder, in that the adjacent layers are sufficiently heated by the energy beam, in particular melted, in order that a diffusion of the powder material is made possible in the workpiece that is forming.

Further details of the teachings are described below on the basis of the drawings. Elements of the drawing that are the same or corresponding are respectively provided with the same reference signs and are only explained more than once if there are differences between the individual figures.

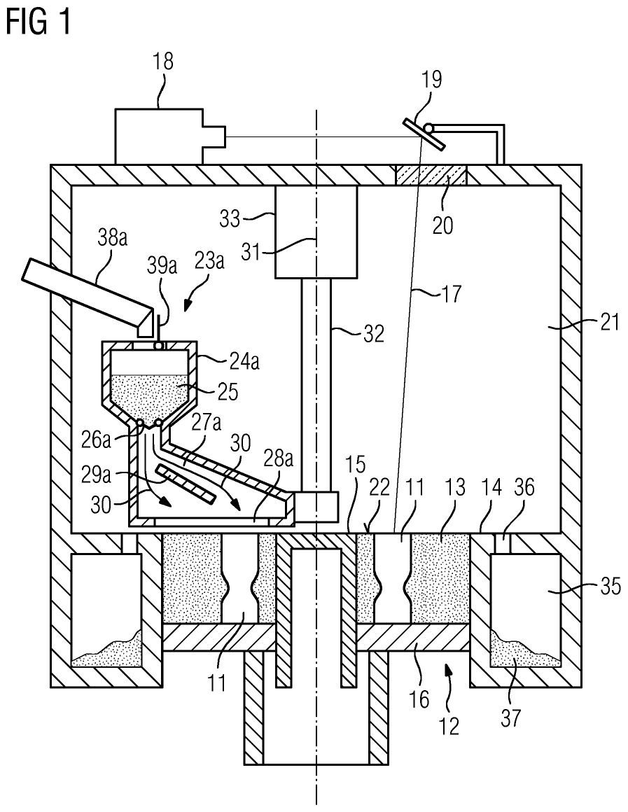

An installation for the additive production of workpieces 11 according to FIG. 1 is configured as an installation for selective laser melting. This has a receiving device 12 for a powder bed 13, this receiving device having an outer border 14, which is formed by a cylindrical wall. Also provided is an inner border 15 for the powder bed, which is likewise formed by a cylinder. The powder bed 13 therefore has the form of a circular ring. The receiving device 12 is also equipped with a building platform 16, on which the workpieces 11 are manufactured layer by layer. For this purpose, the building platform 12 can be lowered by the respective thickness of the layer, this taking place by means of a drive that is not shown any more specifically.

The workpieces 11 are manufactured by means of an energy beam 17 (here a laser beam), which is generated by a laser 18. Indicated is a deflecting optical unit 19 for the laser beam 17, which directs the latter through a window 20 into a process chamber 21, in which the receiving device 12 with the powder bed 13 is provided. The laser 18 is located outside the process chamber 21, as is the deflecting optical unit 19. By means of the deflecting optical unit 19 and also further optical elements that are not shown (for example a focusing optical unit), the energy beam is guided on a surface 22 of the powder bed 13 in such a way that the powder for manufacturing the workpiece 11 is fused, in particular is melted.

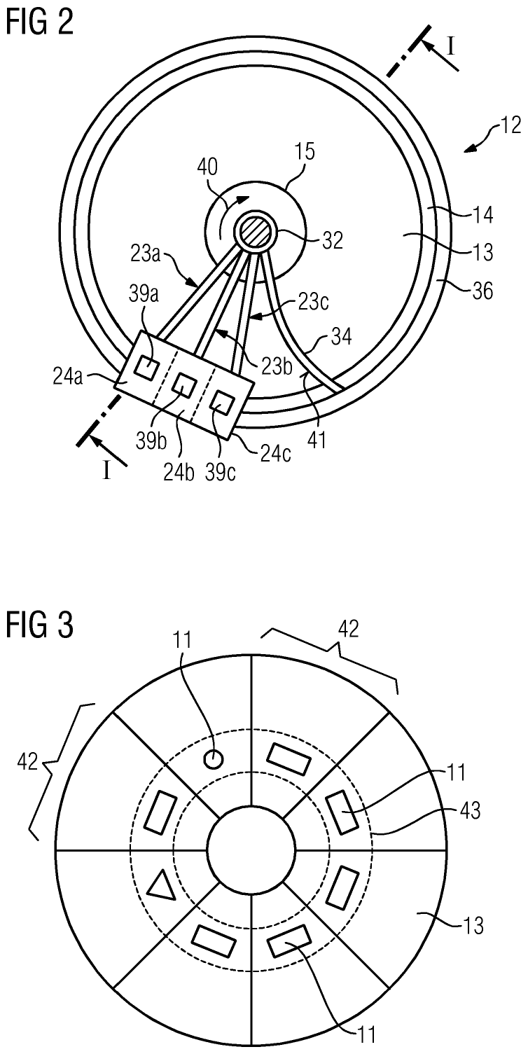

For creating the powder bed 13, multiple metering devices 23a, 23b, 23c (cf. FIG. 2) are arranged in the process chamber 21, of which only the metering device 23a is shown in section in FIG. 1. This is constructed in just the same way as the metering devices 23b, 23c that are not shown and has a storage container 24a, in which powder 25 of a certain type of powder can be stored. By opening metering flaps 26a, the powder can pass through a cavity 27a to a metering slit 28a, through which the powder 25 is distributed uniformly on the surface 22 of the powder bed 13.

In order to distribute the powder uniformly over the length of the metering slit 28, a separating wall 29a by which the stream of the type of powder, indicated by arrows 30, is divided may be arranged in the interior of the cavity 27a. In order to distribute the type of powder of the powder 25 uniformly over the circumference of the powder bed 13 in the form of a circular ring, a relative rotational movement between the receiving device 12 and the metering device 23a is also required. This is generated by the metering device 23a rotating about a center axis 31, which is perpendicular to the surface 22 of the powder bed 13. For this purpose, the metering device 23a is attached to a retaining rod 32, which is arranged in the center axis 31 and can be rotated by a drive 33. In this case, the metering slit 28a brushes over the entire surface 22 of the powder bed 13.

Excess powder can be removed from the surface 22 of the powder bed 13 during the metering by a slide 34 (shown in FIG. 2). In order to catch this powder, a collecting container 35 is available in the installation according to FIG. 1, arranged annularly around the receiving device 12 and having a slit-shaped opening 36, which outwardly adjoins the outer border 14 for the powder bed. Since the building platform 16 is lowered layer by layer, the outer border 14 is always at the height of the surface 22 of the powder bed 13, and so the excess powder can be transported by means of the slide 34 over the outer border 14 into the opening 36. Depending on the application, a collected powder residue 37 may be discarded or used again.

In the position of the metering device 23a that is shown in FIG. 1, it is possible to replenish the storage container 24a with the powder 25 of the desired type of powder by means of a filling device 38a. For this purpose, a powder store arranged outside the process chamber 21 and not shown in FIG. 1 is used. This makes it possible that replenishing of powder 25 can take place without opening the process chamber. The replenishing of powder takes place by opening a filling flap 39a and may be performed for example while the energy beam 17 is creating the workpiece 11 at an accessible location of the powder bed.

In FIG. 2, the receiving device 12 with the powder bed 13 can be seen as a plan view. Arranged above the powder bed are the metering devices 23a, 23b, 23c, which are fastened on the retaining rod 32. With the retaining rod 32, the metering devices are rotated together with the slide 34 in the direction of the arrow (direction of rotation 40). As a result, a metering of different types of powder from the storage containers 24a, 24b, 24c on the powder bed 13 is accomplished. The powder stores are grouped together in a common housing, separating walls between the powder stores being indicated by dashed lines. Seen in the direction of rotation 40, the slide 34 runs behind the metering devices 23a, 23b, 23c over the powder bed 13. This slide is of a curved configuration, excess powder collecting on the concave side 41 and, on account of the curvature of the slide, being transported radially outward during the rotation in the direction of rotation 40. After overcoming the outer border 14, the excess powder falls into the opening 36, which forms an annular slit around the outer border 14.

The powder metering units 23a, 23b, 23c may be opened individually or simultaneously for the metering of powder. In the case of simultaneous opening, the mixing of a number of types of powder on the powder bed 13 within a produced layer of the powder bed is possible. If the metering devices are used individually, it is possible that layers of different types of powder are deposited one after the other onto the powder bed 13.

In FIG. 3, it is schematically shown how the powder bed 13 according to FIG. 2 can be divided into multiple sectors of a circle 42. In each of these sectors of a circle, a different workpiece 11 may be manufactured, it being possible for the workpieces 11 to have different geometries and compositions. In order to be able to plan a change of powder for each component, a change between applied types of powder may take place individually for each sector of a circle 42. It is in this way possible to manufacture workpieces 11 with different material compositions in one manufacturing batch of the installation according to FIG. 1. It can also be seen that the workpieces 11 are all manufactured in one radial region 43 (indicated by a dashed line), which comprises only a sub-region of the overall radial dimensions of the powder bed 13. In this region 43, the circular movement of the metering devices 23a, 23b, 23c may be regarded approximately as linear, and so it is possible to create a concentration gradient which is aligned in the plane of the powder bed 13 and runs linearly from one side of the component to the other.

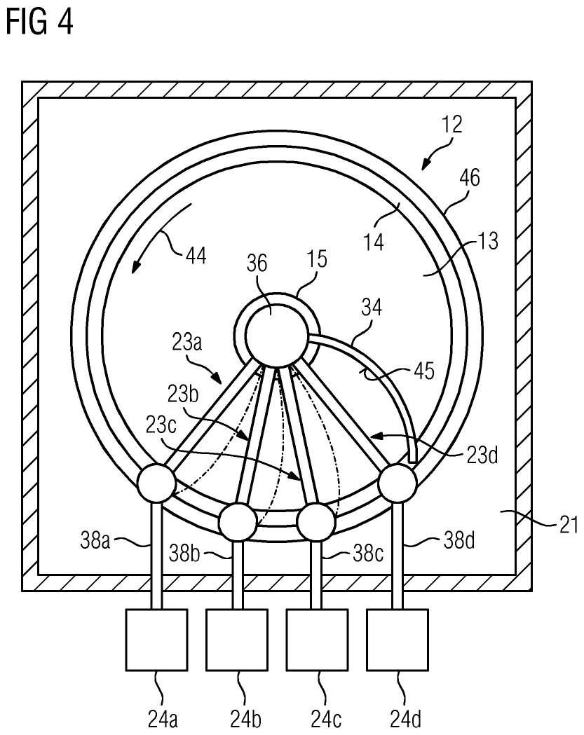

According to FIG. 4, an installation for the additive production of workpieces can be seen, in which the receiving device 12 is arranged rotatably in the direction of an arrow (direction of rotation 44), while the metering devices 23a, 23b, 23c, 23d are arranged fixedly in the process chamber 21. The construction of these metering devices may be substantially the same as that described in relation to FIG. 1, with the difference that the storage containers 24a, 24b, 24c, 24d are arranged outside the housing and supply the metering devices 23a, 23b, 23c, 23d directly with the respective type of powder by means of the filling devices 38a, 38b, 38c, 38d. This is made possible by the fact that the metering devices can be fixedly installed in the process chamber 21, since the relative rotational movement is performed by the receiving device.

A further difference of the receiving device 12 in comparison with FIG. 1 is that the opening 36 for receiving excess powder lies within the inner border 15 of the powder bed. Accordingly, the curved slide 34 is arranged in such a way that excess powder is collected on its concave side 45. By the rotational movement of the powder bed 13 in the direction of rotation 44 underneath the slide 34, the excess powder is therefore carried radially inward, overcomes the inner border 15 and falls into the opening 36. A collecting container that is not shown any more specifically is arranged underneath this opening. The outer border 14 of the receiving device 12 is provided with a sealing lip 46, in order that no excess powder can be lost at the outer border 14.

In some embodiments, the installation according to FIG. 4 could also be equipped with an annular collecting container 35 according to FIG. 1, an opening then having to be provided instead of the sealing lip 46. It is also possible that both the outer border 14 and the inner border 15 have openings 36 for collecting excess powder (both in the case of the installation according to FIG. 4 and in the case of the installation according to FIG. 1). It is also possible in the case of the installation according to FIG. 1 that only an opening at the inner border 15 is provided. The principle for generating the relative movement may also be changed over in the case of the installations according to FIG. 1 and FIG. 4, i.e. such that according to FIG. 1 the receiving device 12 is formed as rotatable and the metering device 23a is formed as fixed in place, and according to FIG. 4 the metering devices 23a, 23b, 23c, 23d are configured as rotatable, as in FIG. 1, and in return the receiving device 12 is fixed in place.

What is claimed is:

1. An installation for the powder-bed-based additive manufacturing of a workpiece, the installation comprising:
a process chamber;
a receiving device for a powder bed in the process chamber;
multiple metering devices for different types of powder, wherein
the metering devices each have a cavity and a metering slit;
wherein the metering slits are arranged radially in relation to a perpendicular center axis running through the receiving device;
wherein the receiving device and the metering devices rotate in relation to one another about the center axis; and
a plurality of storage containers, with at least one storage container for each of the multiple metering devices, wherein each storage container feeds in the respective cavity of the metering device.

2. The installation as claimed in claim 1, wherein the receiving device has an inner border for the powder bed, the inner border separating a region lying around the center axis from the powder bed to be formed.

3. The installation as claimed in claim 1, further comprising:
a slide for smoothing a surface of the powder bed, the slide aligned radially in relation to the center axis;
wherein the receiving device and the slide rotate in relation to one another about the center axis.

4. The installation as claimed in claim 3, wherein the receiving device has an opening for excess powder, the opening adjacent to an outer border for the powder bed and leading into a collecting container.

5. The installation as claimed in claim 4, wherein the opening completely surrounds the outer border.

6. The installation as claimed in claim 3, wherein the receiving device has an opening for excess powder, the opening adjacent to an inner border for the powder bed and leading into a collecting container.

7. The installation as claimed in claim 4, wherein the slide has a curved shape when viewed from above.

8. The installation as claimed in claim 1, wherein:
the storage containers are arranged in the process chamber; and
further comprising a filling device charged with a relevant type of powder outside the process chamber for each storage container.

9. A method for operating an installation for the powder-bed-based additive manufacturing of a workpiece, the method comprising:
building a powder bed in a process chamber;
wherein the process chamber includes a receiving device for the powder bed and multiple metering devices for different types of powder
wherein each metering device includes a metering slit aligned radially in relation to a perpendicular center axis running through the receiving device;
wherein the receiving device and the metering devices rotate in relation to one another about the center axis, while at least one of the types of powder is being distributed on the powder bed through the associated metering slit;
wherein each metering devices includes an associated a storage container connected to a cavity of the metering device;
manufacturing a component using the powder bed.

10. The method as claimed in claim 9, wherein at least two types of powder are distributed on the powder bed through the associated metering slits to create a single layer of the powder bed.

11. The method as claimed in claim 10, wherein a mixing ratio of the types of powder is set by the rotational speed between the metering devices and the receiving device.

12. The method as claimed in claim 11, wherein the rotational speed is varied during the metering of the respective type of powder.

13. The method as claimed in claim 12, wherein a change of the use of the metering devices takes place between the application of two adjacent layers.
